(19) United States
(12) Patent Application Publication
(10) Pub. No.: US 2012/0024157 A1
(43) Pub. Date: Feb. 2, 2012

(54) Method to clean impurities from bio-gas using adsorption

(75) Inventors: Apurva Maheshwary, Edison, NJ (US); John R. Ambriano, Hockessin, DE (US); James J. Flaherty, Hampton, NJ (US); Krishamurti V. Subramanian, Bridgewater, NJ (US)

(73) Assignee: ADSORPTECH INC., MIDDLESEX, NJ (US)

(21) Appl. No.: 12/846,532

(22) Filed: Jul. 29, 2010

(51) Int. Cl. B01D 53/02

(52) U.S. Cl. 96/133; 96/154

(57) ABSTRACT

The present invention provides for a method to make a multiple layered adsorber bed to adsorb and remove water, siloxanes, hydrogen sulfide, mercaptans, and carbon-dioxide from Biogas sources such as landfill gas. This bed can be operated by a pressure swing or vacuum swing adsorption process.

### FIELD OF THE INVENTION

The present invention provides for a layered Adsorber bed which when operated with either a vacuum pressure swing adsorption process (VPSA) or a pressure swing adsorption process (PSA) removes many undesirable impurities from Biogas such as landfill gas. This method can clean the Biogas of several impurities such as siloxanes, water, carbon dioxide, hydrogen sulfide and mercaptans.

### BACKGROUND OF THE INVENTION

Cyclic adsorption processes are frequently used to separate the components of a gas mixture. Typically, cyclic adsorption processes are conducted in one or more adsorbent vessels that are packed with a particulate adsorbent material which adsorbs at least one gaseous component of the gas mixture more strongly than it adsorbs at least one other component of the mixture. The adsorption process comprises repeatedly performing a series of steps, the specific steps of the sequence depending upon the particular cyclic adsorption process being carried out. In any cyclic adsorption process, the adsorbent bed has a finite capacity to adsorb a given gaseous component and therefore the adsorbent requires periodic regeneration to restore its adsorption capacity. The procedure followed for regenerating the adsorbent varies according to the process. In VPSA processes, the adsorbent is at least partially regenerated by creating a vacuum in the adsorption vessel thereby causing adsorbed components to be desorbed from the adsorbent whereas in PSA processes the adsorbent is regenerated at atmospheric pressure. In both VPSA and PSA processes, the adsorption step is carried out at a pressure higher than the desorption or regeneration pressure.

A typical VPSA process, such as detailed in U.S. Pat. No. 5,122,164 generally comprises a series of five basic steps that includes (i) Pressurization of the bed to the required pressure, (ii) Production of the product gas, (iii) Evacuation of the bed, (iv) Purging the bed with product gas under vacuum conditions and (v) Pressure equalization step to minimize vent losses and improve efficiency.

The pressure swing adsorption (PSA) process as described in U.S. Pat. No. 5,507,857 is similar but differs in that the bed is depressurized to atmospheric pressure and then purged with product gas at atmospheric pressure.

As mentioned above, the regeneration process includes a purge step during which a gas stream that is depleted into the component to be desorbed is passed counter-currently through the bed of adsorbent thereby reducing the partial pressure of adsorbed component in the adsorption vessel which causes additional adsorbed component to be desorbed from the adsorbent.

The non-adsorbed gas product may be used to purge the adsorbent beds since this gas is usually quite depleted in the adsorbed component of the feed gas mixture.

Biogas, including landfill gas or waste water gas, is a valuable source of methane which is can be recovered instead of flaring. This invention provides for a method to layer different adsorbents to economically recover methane at Biogas sources where the amount of gas is too small to benefit from previous more costly recovery technologies. Many of the presently used processes and prior art aim to recover methane are economically viable only when the size of the Biogas source is significantly large. This is because they use many discrete unit operations (such as U.S. Pat. No. 7,731,779) to accomplish the clean up and are uneconomic for smaller scale sources such as small landfills and waste water plants. Bio gas contains large numbers of impurities which cause the equipment downstream to corrode or become clogged and subsequently fail. The present invention aims to achieve acceptable reduced levels of impurities such as siloxanes, hydrogen sulfide, mercaptans, water and carbon-dioxide in a reduced number of unit operations. The present invention provides for a new method to accomplish the Biogas purification using a layered combination of multiple adsorbents. This method of layering the bed when applied with generic PSA or VPSA processes using one of more beds can clean the feed gas of the above mentioned undesirable impurities to acceptable levels.

The key advantage of this invention over the prior art is that it allows the entire Biogas purification to be accomplished in a reduced number of unit operations instead of a separate unit operation for every contaminant, thereby reducing the cost, complexity and reliability concerns of the process.

### SUMMARY OF THE INVENTION

The present invention provides for a method of layering the adsorbent bed with multiple adsorbents. This layered bed with multiple adsorbents when used with a conventional PSA or VPSA processes can remove impurities such as water, carbon dioxide, hydrogen sulfide, mercaptans and siloxanes from Biogas. The bed adsorbs the above impurities in the Biogas under pressure to produce purified gas. The multiple layer bed in the present invention can be regenerated by depressurizing, using purified gas purge and heating using a suitably designed internal heat exchanger.

### BRIEF DESCRIPTION OF THE DRAWINGS

FIG. 1 is a representation of a multiple layered adsorption bed for Biogas purification.

FIG. 2 is a representation of steps to operate the multiple layered adsorption bed for Biogas purification.

### DETAILED DESCRIPTION OF THE INVENTION

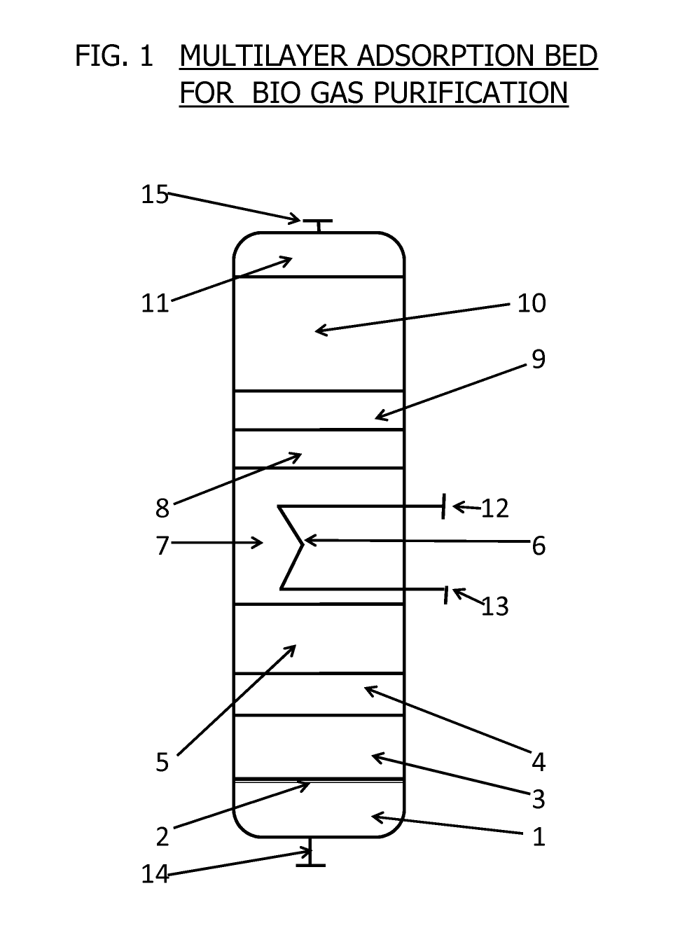

The present invention provides for a method of layering the adsorbent bed with multiple adsorbents. The adsorbent bed will contain multiple layers of Adsorbents to selectively remove various impurities as mentioned earlier. See FIG. 1 for schematic sketch of the Adsorber bed.

At the bottom of the Adsorber bed is an empty space called bottom void space (1) followed by a perforated support plate (2) to support Adsorbent material. The Feed gas enters the bed and the waste gas exits the bed through a specially designed distributor nozzle to facilitate equal distribution of gas flow in the bed, while preventing direct impingement (14).

The present invention provides for, the following layers of adsorbents in the order as described from the bottom of the adsorber bed.

The first layer (3) from the bottom of the claimed design of adsorber bed comprises of a high efficiency activated alumina based adsorbent to adsorb most of the gaseous or dispersed liquid water coming along with the feed gas. This layer could be from 4 to 16 inches thick preferably up to 8 inches thick for most cases depending on the feed temperature and pressure conditions.

The second layer (4) from the bottom of the claimed design of the adsorber bed comprises of a commercial zeolite based adsorbent layer which adsorbs trace amount of water not adsorbed by the first layer. This layer could be from 2 to 6 inches thick, preferably 4 inches thick in most cases.

The third layer (5) from the bottom of the claimed design of the adsorber bed is another zeolite adsorbent layer to remove sulfur compounds including H2S and mercaptans. The zeolite in the third layer has bigger pore sizes than the zeolite adsorbent used in the first layer. This layer is from 6 to 24 inches thick depending on the quantity of the sulfur compounds present in the feed gas, preferably 8 inches thick in most cases.

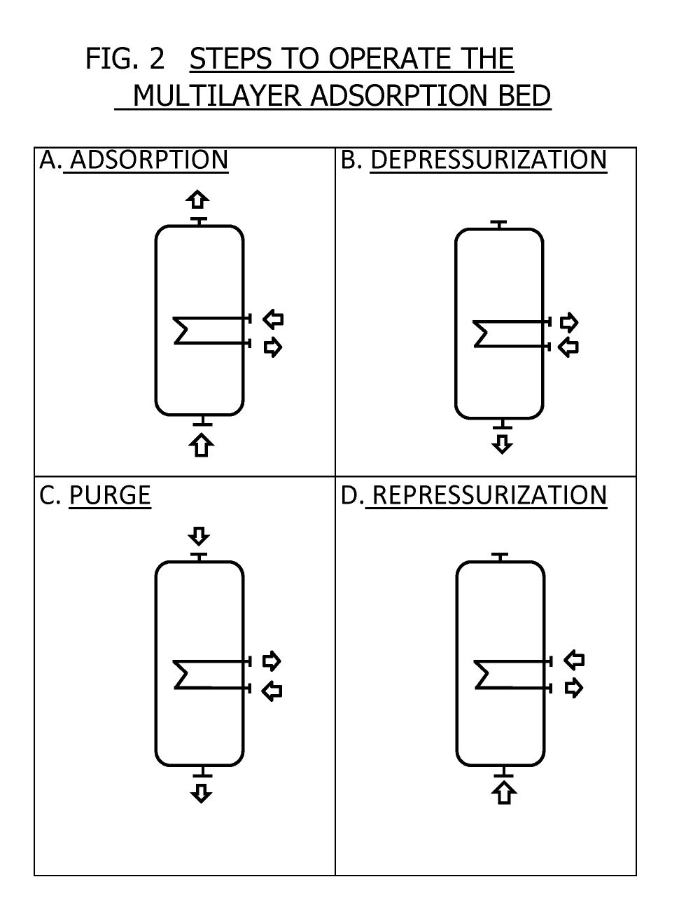

The fourth layer (7) from the bottom of the claimed design of the adsorber bed comprises of a macroporous activated carbon based adsorbent to selectively adsorb siloxanes. This layer has a heating exchanger device (6) which heats the layer up to 200 deg F. during the regeneration step and cools it down to atmospheric temperature during the adsorption step. The cooling fluid enters the heat exchanger at 12 and exits at 13 working countercurrent to the flow of the process gas during the Repressurization and Adsorption steps. The heating fluid during depressurization and purge steps enters at 13 and exits at 12 working countercurrent to the flow of the process gas during these steps. See FIG. 2. for the pictorial depiction of this heat exchanger. The heat exchanging device may be substituted or supplemented with an intrinsically safe electrical heater which only provides heat during the regeneration step. The heating and cooling of the adsorbent layer during the cycle increases the productivity of the adsorbent material. The fourth layer is upto 8 to 24 inches thick preferably 12 inches.

The fifth layer (8) from the bottom of the claimed design of adsorber bed comprises of small pore carbon molecular sieve adsorb small traces of siloxanes from the gas mixture. This layer is up to 8 inches thick, preferably 4 inches thick.

The sixth layer (9) from the bottom is an inert zone and comprises of non-active beaded material. This layer also acts as heat insulation between the seventh layer and the fifth layer besides providing volume to redistribute the gases. The sixth layer is up to 6 inches thick, preferably 4 inches thick.

The seventh layer (10) from the bottom or the top layer of the adsorber bed has a zeolite based adsorbent material to selectively absorb carbon-dioxide from the Biogas. The thickness of this layer depends upon the amount of carbon-dioxide in the gas and level of purity desired in the final product.

The adsorber bed described above will be operated in a PSA or VPSA cycle using four typical steps as described in FIG. 2. These steps are described below.

In Adsorption step (A) the feed gas enters at 14 and the layers of adsorbents as described above remove water, siloxanes, hydrogen sulfide, mercaptans and carbon dioxide. The product gas leaves the bed at 15. The cooling provided by the heat exchanger to the fifth layer increases its adsorption capacity. In Depressurization step (B) the pressure in the bed is reduced from 14 and the heat exchanger reverses the duty from cooling to heating. In Purge step (C) a stream of gas, devoid of the contaminants being removed is introduced at the top to bed at 15 to enhance the regeneration of the beds. The heating of the fifth layer of the adsorber bed helps the regeneration in steps B and C. In Repressurization step (D) the feed gas is reintroduced into the bed at 14 and consequently the pressure of the bed increases. At a preset pressure or time during step D, the product starts to flow out of the bed from 15. The heat exchanger reverses the duty from heating to cooling at the start of step D to enhance the adsorption in fourth layer.

In the multilayer adsorber bed as described in the invention there is an empty space above the top layer called the top void space (11). This void space helps redistribute the incoming purge gas. The outlet nozzle (15) has a specially designed distributor to evenly spread the purge gas in the top void.

The present invention also provides for a flexible perforated separation between each subsequent layer to prevent intermixing of adsorbents and redistribution of gases in the adsorber bed. This perforated separation is thick enough to act as an insulating barrier between the layers which is an important criterion for this invention to function as desired.

In another variation of the present invention the layers of different adsorbent can be arranged in multiple vessels for easy maintenance or removal. In any case, the sequence of layering the adsorbents will be unchanged.

In another variation of the present invention an eighth layer may be added to the top of the bed with an adsorbent designed to selectively adsorb Nitrogen and Oxygen from the Biogas. This will allow the final product to be good for use as pipeline quality gas in case Nitrogen and Oxygen level are higher than acceptable.

Having thus described the invention, what we claim are:

1. A multiple layer adsorber bed using a pressure swing or vacuum swing adsorption process for separating siloxanes, hydrogen sulfide, mercaptans, water and carbon dioxide from a Biogas source such as Landfill gas.

2. The multilayer adsorber bed in claim 1 has an alumina based adsorbent layer for bulk water adsorption as the first layer.

3. The multilayer adsorber bed in claim 1 has a zeolite based adsorbent layer for trace water adsorption as the second layer.

4. The multilayer adsorber bed in claim 1 has a zeolite based adsorbent layer for hydrogen sulfide and mercaptans adsorption as the third layer.

5. As an alternate the multilayer adsorber bed in claim 1 has a silica gel based adsorbent layer for hydrogen sulfide and mercaptans adsorption as the third layer.

6. The multilayer adsorber bed in claim 1 has a macroporous activated carbon based adsorbent layer for siloxanes adsorption as the fourth layer.

7. The fourth layer of adsorbent in the claim 1 adsorber bed also has a heat exchanger to counter-currently heat the layer during regeneration and also counter-currently cool the layer during adsorption.

8. The multilayer adsorber bed in claim 1 has a microporous carbon based adsorbent layer for adsorb trace siloxanes as the fifth layer.

9. The multilayer adsorber bed in claim 1 has an inert material layer as a sixth layer.

10. The multilayer adsorber bed in claim 1 has a zeolite based adsorbent layer for carbon-dioxide adsorption as the seventh layer.

11. The multilayer adsorber bed in claim 1 can be arranged inside a single vessel.

12. The multilayer adsorber bed in claim 1 can be arranged inside multiple vessels such that the layers of adsorbent occur in the same order.

13. The multilayer adsorber bed in claim 1 can be built without a heat exchanger with additional sieve in the fourth layer.

14. The multilayer adsorber bed in claim 1 can use electrical heater to increase the regeneration in the fourth layer.

15. The multilayer adsorber bed in claim 1 has perforated separation between each subsequent layer of adsorbent.

16. The multilayer adsorber bed in claim 1 can have an eighth layer of adsorbent which can selectively adsorb Nitrogen and Oxygen.
